(19) United States
(12) Patent Application Publication
(10) Pub. No.: US 2006/0158133 A1
(43) Pub. Date: Jul. 20, 2006

(54) Method and device for driving a matal halide lamp

(75) Inventors: Fransiscus Arnoldus Vermeulen, Eindhoven (NL); Johannes Jacobus Franciscus Geijtenbeek, Eindhoven (NL); Johan Leopold Victorina Hendrix, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,922

(22) PCT Filed: Jul. 1, 2004
(86) PCT No.: PCT/IB04/51098

§ 371 Date: Jan. 9, 2006

(30) Foreign Application Priority Data
Jul. 10, 2003 (EP) 03102074.6

(51) Int. Cl. H05B 39/04

(52) U.S. Cl. 315/209 R

(57) ABSTRACT

A method is described for driving a gas discharge lamp (1), specifically a HID lamp, more specifically a metal halide lamp, most specifically a metal halide lamp with an aspect ratio larger than 3 or even 4. The lamp is supplied with a commutating DC current having a duty cycle (D) and an average current intensity (I_{AV}) at a certain electrical output power. The method comprises the step of varying the average current intensity (I_{AV}) and the electrical output power in order to vary the color temperature of the lamp. Preferably, the average current intensity (I_{AV}) is changed by changing the duty cycle (D), and the electrical output power is varied in relation to the average current intensity (I_{AV}).

### FIELD OF THE INVENTION

The present invention relates in general to a method and device for driving a gas discharge lamp, specifically a HID lamp, more specifically a metal halide lamp.

### BACKGROUND OF THE INVENTION

Gas discharge lamps are commonly known. In general, they comprise a light transmitting vessel enclosing a discharge chamber in a gastight manner, an ionizable filling and a pair of electrodes located opposite each other in the discharge chamber, each electrode being connected to an associated current conductor which extends from the discharge chamber through the lamp vessel to the exterior. During operation, a voltage is applied over said electrodes, and a gas discharge occurs between said electrodes causing a lamp current to flow between the electrodes. Although it is possible to drive an individual lamp within a relatively wide range of operating currents, a lamp is typically designed for being operated at a specific lamp voltage and lamp current and thus to consume a specific nominal electric power. At this nominal electric power, the lamp will generate a nominal amount of light. Since HID lamps are commonly known to persons skilled in the art, it is not necessary to discuss their construction and operation here in more detail.

A high-pressure discharge lamp is typically driven by an electronic ballast supplying commutating DC current. In an exemplary implementation, an electronic ballast or driver for such a lamp typically comprises an input for receiving AC mains, a rectifier for rectifying the AC mains voltage to a rectified DC voltage, a DC/DC up converter for converting the rectified mains DC voltage to a higher DC voltage and usually also for performing a power factor correction for the net current, a down converter for converting said higher DC voltage to a lower DC voltage (lamp voltage) and a higher DC current (lamp current), and a commutator for regularly changing the direction of this DC current. The down converter behaves as a current source. Typically, the commutator operates at a frequency in the order of about 50-400 Hz. Therefore, in principle, the lamp is operated at constant current magnitude, the lamp current regularly changing its direction within a very brief time (commutating periods) in a symmetric way, i.e. an electrode is operated as a cathode during 50% of each current period and is operated as anode during the other 50% of each current period. This mode of operation will be indicated as square wave current operation.

Although many of the aspects of the present invention are also applicable to different lamp types, the present invention relates specifically to metal halide lamps with a relative large aspect ratio, i.e. the ratio of length/diameter is larger than 3 or even 4; conventionally, the aspect ratio is typically in the order of 2.

In metal-halide lamps, segregation may occur, i.e. the spatial distribution of the particles is dependent on the location along the axis of the lamp. This phenomenon occurs naturally (induced by gravity) when the lamp is in a vertical orientation, and is caused by physical effects like convection and diffusion, both determined by the atmospheric condition within the lamp. The amount of segregation depends on circumstances like pressure and type of material of the ionizable filling. The segregation effect increases with increasing electrode spacing, i.e. with increasing aspect ratio.

Segregation may also be effected by controlling electrical parameters during lamp operation. In an earlier patent application PCT/IB03/01547, the present applicant has described that the particle distribution can be shifted by driving the lamp with a commutating DC current having an average DC level differing from zero, preferably by controlling the duty cycle of the current. As a result, it is possible to vary the color temperature of the lamp within a wide range between approximately 2500 K and approximately 4200 K.

This earlier patent application describes that a standard electronic driver is provided with a control input for setting the DC current level, preferably for setting the duty cycle, respectively. In case the duty cycle is maintained at 50%, the DC current level is set by having the positive current magnitude and the negative current magnitude differing from each other. Preferably, however, the current magnitude is kept constant, i.e. the positive current magnitude is equal to the negative current magnitude, and the duty cycle is controlled, in principle between 0% and 100%, to obtain the desired DC current level.

Apart from said control input for setting the DC current level, standard electronic drivers are designed to keep the average output power, i.e. the electrical power supplied to the lamp, substantially constant. It has appeared that, when the duty cycle of the current is varied in order to traverse a color temperature range from low temperature to high temperature while using a standard electronic driver, i.e. a driver that keeps the average electrical output power constant, the color rendering index (CRI) and efficacy (Lumen per Watt) decrease.

The color rendering index and efficacy can be improved by increasing the salt temperature, which can be effected by increasing the electrical power setting of the driver. However, in that case the duty cycle is varied at a higher output power setting, so the color rendering index and efficacy are increased at low color temperature as well as at high color temperature. Accordingly, even for the higher output power setting, the problem remains that the color rendering index and efficacy for a higher color temperature are lower than for a lower color temperature. Further, it has been found that the color temperature range itself depends on electrical power: if the electrical power is increased, the color temperature range shifts to higher temperatures, so that it is not possible any more to obtain a desired low color temperature.

It is a general objective of the present invention to overcome or at least reduce the above problems.

More particularly, the present invention aims to provide a method and device for driving a gas discharge lamp such that the color temperature can be varied over a large color temperature range while maintaining a sufficiently high color rendering index and efficacy, preferably keeping the color rendering index and/or light output substantially constant.

### SUMMARY OF THE INVENTION

According to an important aspect of the present invention, a lamp is driven with a variable electrical power, such that in a setting for low color temperature a relatively low electrical power is used whereas in a setting for high color temperature a relatively high electrical power is used. Thus, the advantages of a wide color temperature range and high color rendering index and efficacy are combined. Actually, for the same duty cycle range, the color temperature range is even effectively increased in that the high temperature limit shifts to a higher value.

The change in electrical power may be discontinuous. For instance, it is in principle possible, and within the scope of the present invention, to set a color temperature within a low-temperature portion of the color temperature range while using a first, relatively low electrical power, and to set a color temperature within a high-temperature portion of the color temperature range while using a second, relatively high electrical power. However, it is preferred that the electrical power is changed in a continuous way when traversing the color temperature range.

In a specific embodiment, a lamp driver is provided with a memory comprising information such as a table relating to a relationship between duty cycle setting and power setting. In operation, the lamp driver sets a duty cycle on the basis of the command signal received at its duty cycle command input, and sets an output power on the basis of the information in said table in conjunction with the duty cycle as set.

Such a memory allows a manufacturer to implement a certain power characteristic that is preferred by the manufacturer, for instance because it is believed to be an optimal characteristic. However, it may be that non-optimal characteristics are sufficiently satisfactory or acceptable as well. In such case, an elegant and simple embodiment of a lamp driver in accordance with the present invention takes advantage of the experimentally found result that, due to the shifted particle distribution caused by the DC current level, the lamp voltage increases when a color temperature range is traversed from low temperature to high temperature. Based on this phenomenon, this simple embodiment of the lamp driver keeps the current magnitude constant when the duty cycle is varied in order to traverse a color temperature range.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates a metal-halide lamp;

FIG. 2 is a block diagram schematically illustrating an electronic ballast;

FIG. 3A is a graph showing lamp current as a function of time for illustrating square wave current operation;

FIG. 3B is a graph showing lamp current as a function of time for illustrating operation with current magnitude control in order to obtain an average DC current;

FIG. 3C is a graph showing lamp current as a function of time for illustrating operation with duty cycle control in order to obtain an average DC current;

FIGS. 4A-B are chromaticity diagrams showing experimental results of travelling a color line using a prior driver;

FIG. 4C is a chromaticity diagram showing experimental results of travelling a color line using a driver according to the present invention.

### DESCRIPTION OF THE INVENTION

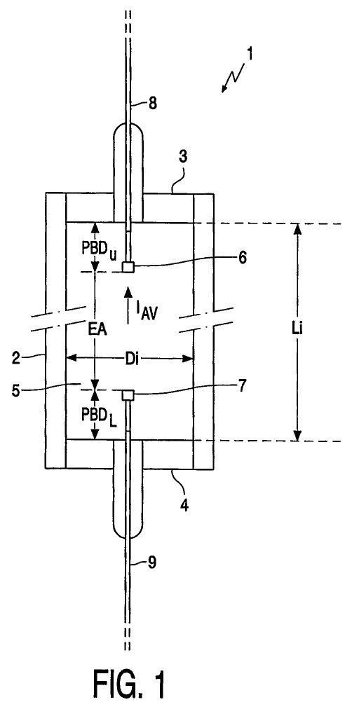

FIG. 1 schematically shows a possible embodiment of a metal-halide lamp, generally indicated at reference numeral 1. The lamp 1 comprises a light transmissive vessel 2, in the embodiment illustrated having a circular cylindrical shape and having an internal diameter Di; however, other shapes are possible, too. Although not essential in the context of the present invention, the vessel 2 is preferably made from ceramic material; as an alternative, the vessel 2 could be made from quartz. At its longitudinal ends, the vessel 2 is closed in a gas-tight manner by plugs or end caps 3, 4 of a compatible material. The vessel 2 and the plugs and/or end caps 3, 4 enclose a discharge chamber 5 having a diameter equal to the internal diameter Di of the vessel 2 and having an axial length Li determined by the distance between the end caps 3 and 4. An aspect ratio AR is defined as the ratio Li/Di.

Inside the discharge chamber 5, two electrodes 6, 7 are arranged at a mutual distance EA, substantially aligned with the central axis of the vessel 2. In a gas-tight manner, electrode conductors 8, 9 extend from the electrodes 6, 7 through the end caps 3, 4, respectively. If the end caps 3, 4 are made from quartz, the conductors 8, 9 may be molten into the quartz. Typically, the electrodes 6, 7 will be made from a material differing from the material of the electrode conductors 8, 9; by way of example, the electrodes 6, 7 may be made from tungsten.

Inside the discharge vessel 2, i.e. in the discharge chamber 5, an ionizable filling is arranged. The filling typically comprises an atmosphere comprising a substantial amount of mercury (Hg). Typically, the atmosphere also comprises elements like xenon (Xe) and/or argon (Ar). In a practical example, where the overall pressure inside the discharge vessel 2 is in the order of 1-2 atm, argon and xenon may be present in the ratio 1:1. In another practical example, where the overall pressure is in the order of 10-20 atm, the discharge chamber may contain mercury and a relatively small amount of argon. In the following, those examples of commercially available lamps will be indicated as relatively low pressure lamp and relatively high pressure lamp, respectively.

The discharge vessel 2 also contains one or more metal-halide substances. Although these may comprise bromides or other halides, these substances typically comprise iodides. Typical examples of such possible substances are lithium iodide, cerium iodide, sodium iodide. Other substances are possible, too.

The metal halides are provided as a saturated system comprising an excess amount of salt, such that during operation of the lamp a salt pool of melted salt will be present inside the discharge chamber 5. In the following, it will be assumed that the salt pool is located at the lowest location inside the discharge chamber 5.

In operation, a discharge will extend between the electrodes 6, 7. Due to the high temperature of the discharge, said substances will be ionized and will produce light. The color of the light produced is different for different substances; for instance, the light produced by sodium iodide is red while the light produced by cerium iodide is green. Typically, the lamp will contain a mixture of suitable substances, and the composition of this mixture, i.e. the identity of said substances as well as their mutual ratio, will be chosen such as to obtain a specific desired overall color.

As already explained in PCT/IB03/01547, it is possible to manipulate the particle distribution in the discharge vessel 2, and thus to manipulate the color temperature of the light produced by a metal halide lamp, by operating the lamp with a lamp current having an average DC current component differing from zero, preferably by controlling the duty cycle, as will be explained in more detail. This results in an average electrical field between the electrodes 6, 7, which induces a shift of the particle distribution, such that the concentration of positive particles close to the negative electrode is increased. As a result, an axial gradient of particles will be established. This phenomenon will also be termed “current induced distribution shift”.

The above already applies if a lamp contains only one light generating substance. In the case of a mixture of substances, the above applies also, but to a different extent for the various components in the mixture. Since the overall color impression of the light produced by the lamp depends on the light contributions from the various components of the mixture, segregation causes a change of the color of the light produced by the lamp as a whole. For instance, in the case of a lamp containing a mixture of sodium iodide and cerium iodide in a predetermined ratio, in a vertical orientation, segregation around the upper electrode 6 reduces the amount of reddish light produced by the sodium iodide and reduces the amount of greenish light produced by the cerium iodide, wherein the reduction of greenish light is more than the reduction of reddish light, so that the overall impression of the color of the light produced around the upper electrode 6 will have shifted to reddish.

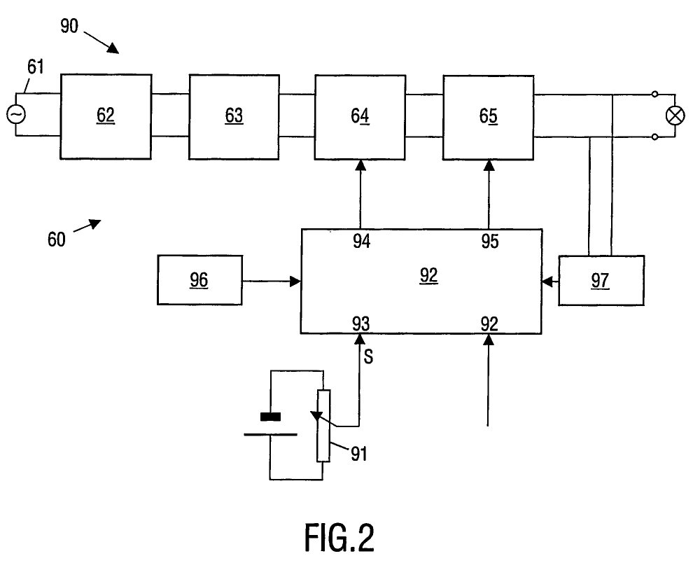

FIG. 2 is a block diagram schematically illustrating a preferred embodiment of a driver device or electronic ballast 60 according to the invention for driving a lamp 1 in a lamp system 90 with variable color properties. The ballast 60 typically comprises:

an input 61 for receiving AC mains;

a rectifier 62 for rectifying the AC mains voltage to a rectified DC voltage;

a DC/DC up-converter 63 for converting the rectified mains DC voltage to a higher DC voltage and for performing power factor correction;

a down-converter 64 for converting said higher DC voltage to a lower DC voltage (lamp voltage) and a corresponding DC current (lamp current);

and a commutator 65 for regularly changing the direction of this DC current within a very brief time (commutating periods).

The driver 60 further comprises a control circuit 92 having a first control output 94 coupled to the down-converter 64 and having a second control output 95 coupled to the commutator 65. The control circuit 92 is adapted for controlling the operation of the down-converter 64, more particularly for controlling the magnitude of its output current, while further the control circuit 92 is adapted for controlling the operation of the commutator 65, more particularly for controlling its duty cycle.

The driver 60 further comprises a control setting device 91, such as for instance a potentiometer, generating a control signal S which can be varied continuously within a predetermined range. The control setting device 91 can be user-controllable, but it can also be a suitably programmed controller. The control circuit 92 has a control input 93 receiving said control signal S.

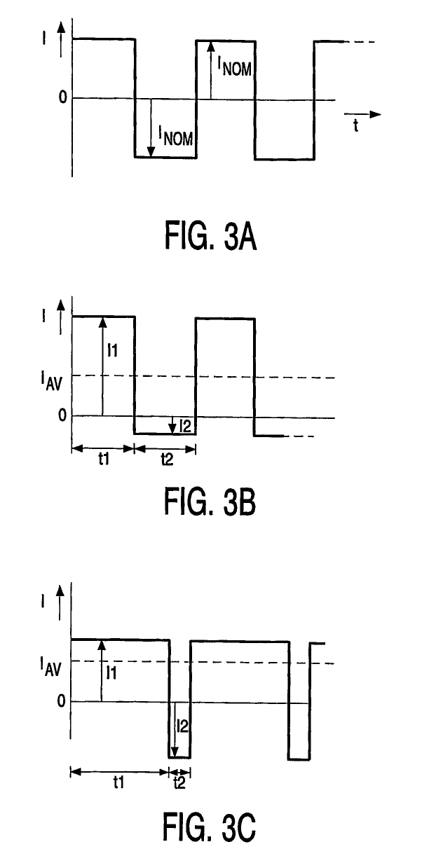

Conventionally, a driver is designed such that its output may be considered as constituting a current source with alternating current direction but constant current magnitude, having a duty cycle of 50%, i.e. the intervals of one current direction have equal duration as the intervals of opposite current direction, such that each electrode is operated as a cathode during 50% of each current period and is operated as anode during the other 50% of each current period. FIG. 3A is a graph showing the lamp current I as a function of time, illustrating this square wave current operation. It is clearly shown that the magnitude of the lamp current remains substantially constant (INOM), but the direction of the current is changed on a regular basis, indicated as a change of the sign of the current from positive to negative and vice versa. In a full current period, the current flows from the first electrode 6 to the second electrode 7 during 50% of the time (positive current interval), and in the opposite direction during the remaining 50% of the time (negative current interval). Thus, the average current I_{AV} is zero.

As mentioned, for inducing a shift of the particle distribution, the lamp current is given an average current I_{AV} differing from zero. Specifically, the control circuit 92 is responsive to the control signal S received at its control input 93 to set a certain value for the average DC current I_{AV}.

FIG. 3B illustrates one possibility of implementing the present invention. In this case, the average current I_{AV} differs from zero because the current intensity during the positive current period differs from the current intensity during the negative current period. Again, the current may have a duty cycle of 50%, i.e. the current flows in one direction during 50% of the time (t1), and in the opposite direction during the remaining 50% of the time (t2), but the current magnitude I1 during the positive periods t1 is larger than the current magnitude I2 during the negative periods t2. Thus, on average, an average DC current I_{AV} flows from the first electrode 6 to the second electrode 7, indicated by the dashed line I_{AV}.

However, this type of implementation is not preferred, one reason being that the lamp current magnitude I1 during the “positive” half of a current period (t1) differs from the current magnitude I2 during the “negative” half of the current period (t2), i.e. the current intensity is not constant in time. Since the light intensity is proportional to the current intensity, this might lead to undesirable flicker of the lamp. Another reason is that it is relatively difficult to implement this method in existing driver designs.

In the following, the present invention will be explained in more detail for the case of a preferred implementation of the present invention, illustrated in FIG. 3C, in which this disadvantage is avoided, and which furthermore is easier to implement by an appropriate software or hardware adaptation in existing lamp drivers. However, it is noted that the same or similar results can be obtained by having the positive current magnitude and the negative current amplitude differing from each other.

In this preferred implementation, the duty cycle differs from 50% and the current intensity remains constant at all times, i.e. the lamp current magnitude I1 during the “positive” half of a current period (t1) is equal to the current magnitude I2 during the “negative” half of the current period (t2). In the example of FIG. 3C, the “positive” current magnitude I1 is equal to the “negative” current magnitude I2, but the “positive” current interval t1 lasts longer than the “negative” current interval t2, so that, on average, an average current I_{AV} flows from the first electrode 6 to the second electrode 7, indicated by the dashed line I_{AV}.

In both cases mentioned, i.e. current magnitude control as well as duty cycle control, said average current I_{AV} will induce a shift of the distribution of the positive ions towards the upper electrode 6, as described above. However, it has been found that this distribution shift is stronger in the case that a certain average current I_{AV} is obtained by duty cycle control as compared to the case that the same average current I_{AV} is obtained by current magnitude control, which is a further reason why the duty cycle control method is preferred over the current magnitude control method.

Thus, according to this preferred aspect of the present invention, the driver 60 is designed to have an adaptable duty cycle. Specifically, the driver 60 is responsive to a duty-cycle control signal S received at control input 93 of the controller 92 to set a certain duty cycle.

With such a system, it has appeared possible to control a lamp such that a well-defined line is traveled in the standard XY-color or chromaticity diagram. With the composition of the salt mixture, a certain zero color point in this diagram can be selected. By varying the duty cycle of the commutating current, the color point of the lamp shifts along a line intersecting said zero color point. Specifically in the case of a high pressure lamp (i.e. overall lamp pressure higher than about 10 atm), said line will substantially be perpendicular to color isotherms, which involves a large variation in color temperature. A user, when using this system, will typically vary said control signal S while observing the color temperature of the lamp, leaving the control setting device 91 in a condition corresponding to a desired color temperature.

The lamp may be placed in a vertical orientation as well as in a horizontal orientation. As explained above, segregation will occur if a metal-halide lamp is mounted vertically, and this segregation can be reduced or increased by applying a DC current component. The important feature in this respect is that it is possible to change the particle distribution instantaneously by applying a DC current component. This feature is not restricted to vertical lamp orientation.

In the case of a lamp having vertical orientation, in principle, the duty cycle D can be varied from 0 to 100%. Herein, the upper electrode 6 can be made negative with respect to the lower electrode 7 in order to reduce segregation to a desired extent, as described above, but the upper electrode 6 can also be made positive with respect to the lower electrode 7 in order to increase segregation and enhance the color separation effect or color changing effect.

In a horizontal lamp orientation, a salt pool will have formed at a certain location, which, in the case of a symmetrical, long, thin lamp, typically is one end or both ends of the lamp. There is balance between inflow and outflow of particles into and out of the salt pool, corresponding to a certain particle distribution inside the lamp. According to the invention, it is possible to shift this particle distribution by applying a DC current component. This phenomenon will also be termed “current induced distribution shift”.

In order to obtain a defined initial situation in the case of a symmetrical lamp, it is possible to operate the lamp at DC current (e.g. duty cycle 0%). Then, after some time, the salt pool will be located at one of the two ends of the lamp; segregation is now at a maximum.

From this initial situation, the segregation can be reduced by raising the duty cycle from 0%. With increasing duty cycle, a new balance will establish between inflow and outflow, the salt pool initially staying substantially in place. The segregation can be eliminated by raising the duty cycle further. A duty cycle in the order of 50% and more leads to an undesired transportation of salt, i.e. segregation in the opposite direction.

Thus, in the case of a horizontal lamp orientation, a duty cycle range between 0% and 50% determines the color range of the lamp. When the duty cycle is 0%, the light produced by the lamp can be represented by a certain color point in the chromaticity diagram. The exact location of this color point, which will also be termed “horizontal zero” color point, depends on the composition of the mixture of elements within the lamp, and can be selected by suitably selecting this composition, as will be clear to a person skilled in the art. If the duty cycle is increased, the color point will shift away from the horizontal zero color point. An end point is reached when the duty cycle reaches 50%. Thus, the color point will travel a line in the chromaticity diagram, hereinafter termed “color line”, which has one end point defined by the horizontal zero color point and an opposite end point defined by 50% duty cycle.

If the initial situation is reversed, i.e. by initially setting the duty cycle to 100%, changing the duty cycle from 100% to 50% will yield substantially the same results.

It is noted that, in practice, a lamp may be asymmetric, for instance by design or arrangement in an outer envelope or armature, such that the lamp has a predetermined cold spot at one end. The same principles as mentioned above apply, but the above-mentioned “end point” may be reached at a different value of the duty cycle.

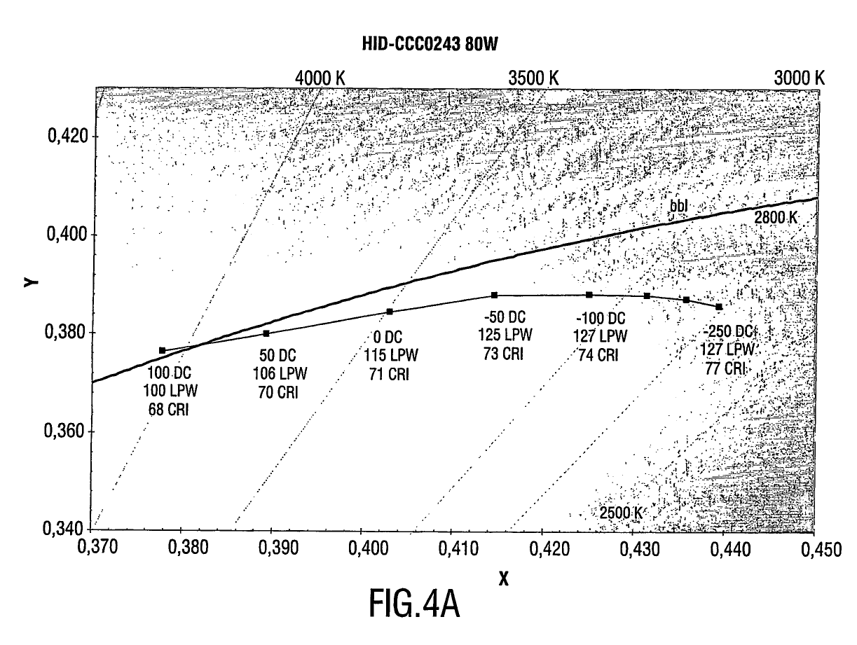

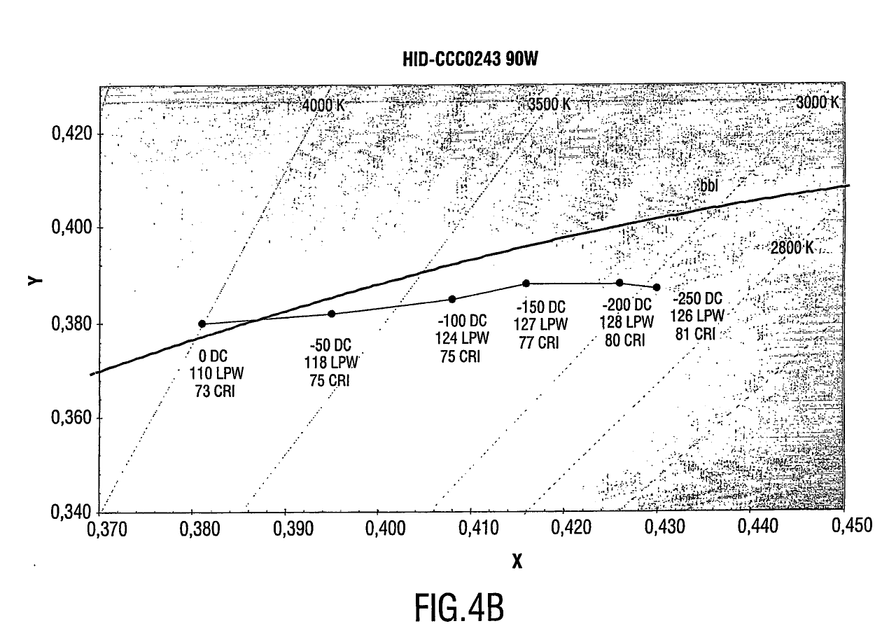

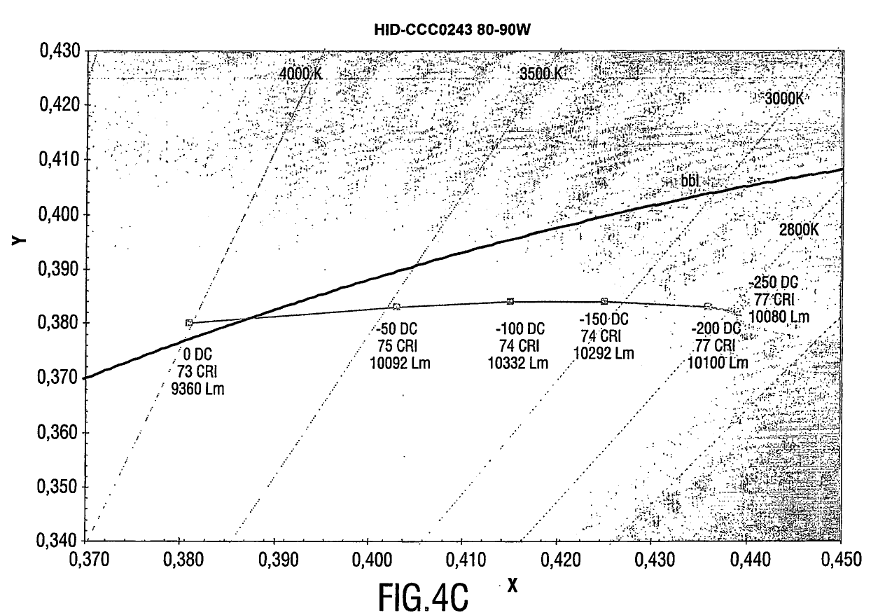

FIGS. 4A and 4B are chromaticity diagrams, containing the black body line BBL and several isotherms, and showing results of an experiment conducted with one vertically oriented lamp of type HID-CCC0243 driven by a prior driver, i.e. a driver designed to keep the average output power constant, yet adapted to have a variable duty cycle. This lamp of type HID-CCC0243 has the following parameters:

| | |
|---|---|
| axial length Li: | 16 mm |
| internal diameter Di: | 4.5 mm |
| wall thickness: | 0.8 mm |
| composition of salt filling: | NaI and CeI3 at mol ratio 7:1; |
| overall pressure in rest: | 25 bar |

This lamp was operated at different settings of the duty cycle, while the average electrical power was maintained constant at a predetermined value. The settings of the duty cycle where selected such as to obtain predetermined values of the average DC current. At each setting of the average DC current (DC), the efficacy (LPW, Lumen Per Watt), Color Rendering Index (CRI), and chromaticity coordinates X and Y were measured. The measured chromaticity coordinates X and Y determine a position of a measuring point in the chromaticity diagram, indicated as a black square. The corresponding values of DC, LPW and CRI are indicated next to each measuring point.

In the case of FIG. 4A, the current magnitude was approximately 500 mA at a duty cycle of 50%. The duty cycle was varied, and the driver was controlled to keep the electrical lamp power constant at 80 W.

It can be seen in FIG. 4A that a color temperature of 2800 K is obtained when the average DC current DC=−250 mA (corresponding to a duty cycle of approximately 25%, the upper electrode being negative on average), and that the color temperature increases to 4100 K if the DC value is increased to +100 mA (corresponding to upper electrode positive on average). It can also be seen that the CRI value decreases from 77 to 68 when the DC value is changed from −250 mA to +100 mA. It can also be seen that the LPW value decreases from 127 to 100 when the DC value is changed from −250 mA to +100 mA.

In the case of FIG. 4B, the same measurements were performed, but now the driver was controlled to keep the electrical lamp power constant at 90 W. The current magnitude was approximately 560 mA at a duty cycle of 50%. It can be seen in FIG. 4B that a color temperature of about 2950 K is obtained when the average DC current DC=−250 mA, and that the color temperature increases to about 4000 K if the DC value is increased to zero (higher values of the color temperature are easily obtainable by further increasing the DC value, but this experiment was stopped when a temperature of 4000 K was reached). It can also be seen that the CRI value decreases from 81 to 73 when the DC value is changed from −250 mA to 0 mA. It can also be seen that the LPW value decreases from 126 to 110 when the DC value is changed from −250 mA to 0 mA.

Thus, when comparing the measurement results of FIG. 4B with those of FIG. 4A, it can clearly be seen that increasing the lamp power from 80 W to 90 W yields an improvement of the CRI value for all settings of the DC value. However, a disadvantage of increasing the lamp power from 80 W to 90 W is the fact that, in case of a lower limit of −250 mA for the DC value, the lower limit of the color temperature range has increased to 2950 K: lower values are not attainable, whereas driving the lamp at 80 W allows reaching down as far as approximately 2800 K. In this respect it is noted that the lower limit of −250 mA for the DC value under these conditions is caused by the finding that undesirable salt transport occurred if the absolute value of the DC value was increased further.

In fact, increasing the lamp power from 80 W to 90 W results in all measuring points being shifted towards higher temperature values (to the left in the Figure). This is made visible in the table below, which contains the results of FIG. 4A as well as the results of FIG. 4B.

| | |
|---|---|
| 80 W | 90 W |

| DC (mA) | CT | CRI | CT | CRI |
|---|---|---|---|---|
| −250 | 2800 | 77 | 2950 | 81 |
| −200 | 2900 | 76 | 3100 | 80 |
| −150 | 2950 | 74 | 3300 | 77 |
| −100 | 3100 | 74 | 3400 | 75 |
| −50 | 3300 | 73 | 3700 | 75 |
| 0 | 3500 | 71 | 4000 | 73 |
| 50 | 3800 | 70 | | |
| 100 | 4100 | 68 | | |

This result may be generalized as follows: in each setting of the duty cycle or DC value, if the average electrical power is increased, the color temperature is increased and the color rendering index is increased.

The above result may also be summarized as follows. If the color temperature is maintained constant, increasing the average electrical power will result in an increase of the color rendering index. For example, at 80 W a color temperature of 3300 K is achieved at CRI=73, while the same color temperature at 90 W is achieved at CRI=77.

The present invention proposes a lamp driving method for varying the color temperature of the light generated by the lamp, such that the color temperature range is relatively large while the color rendering index is relatively high.

More particularly, the lamp driving method of the present invention offers the advantages of a relatively low value for the lower limit of the color temperature range, a relatively high value for the upper limit of the color temperature range, and a substantially constant color rendering index (at least, the CRI value does not change so much as in the case of constant power).

According to the method proposed, by the invention, the setting of the electrical power is dependent on the duty cycle. For a low value of the duty cycle, i.e. corresponding to a low color temperature, the electrical power is relatively low. For higher values of the duty cycle, the electrical power is increased correspondingly.

FIG. 4C is a diagram comparable to FIGS. 4A anf 4B, showing the results of an experiment with the same lamp as mentioned above, now driven by a driver 60 according to the present invention. The color temperature was varied over a range from 2800 K to 4000 K by varying the duty cycle from 25% to 50% (i.e. varying the DC value from −250 mA to 0 mA) while simultaneously varying the average electrical power. When the duty cycle was set to 25%, the electrical power was set to the relatively low value of 80 W. When the duty cycle was increased, the electrical power was also slowly increased, the increase in electrical power being in proportion with the increase in DC value, until the electrical power was set to the relatively high value of 90 W when the DC value reached zero. The results are also shown in the table below.

| DC (mA) | power | CT (K) | CRI |
|---|---|---|---|
| −250 | 80 W | 2800 | 77 |
| −200 | 82 W | 2850 | 77 |
| −150 | 84 W | 3100 | 74 |
| −100 | 86 W | 3300 | 74 |
| −50 | 88 W | 3500 | 75 |
| 0 | 90 W | 4000 | 73 |

It can clearly be seen that the CRI value remains substantially constant over the entire color temperature range.

In contrast to FIGS. 4A and 4B, FIG. 4C shows the light output (Lumen) at each measuring point. It can clearly be seen that the light output remains substantially constant, at least better constant than in thet cases of FIGS. 4A and 4B.

It is noted that in this experiment the color line was travelled between CT=2800 K and CT=4000 K, and the highest value of the electrical power was set only at the end point of this color line trajectory. However, it is possible to travel the color line further, beyond 4000 K, by increasing the DC value above zero, as was done in the case of FIG. 4A. In that case, it is possible that the relationship between duty cycle and power setting is changed such that the highest value of the electrical power is reached at the new end point of the color line trajectory. It is, however, also possible that the electrical power is maintained at its highest value for color temperatures above 4000 K.

It is noted that another relationship between duty cycle and power setting may also be found suitable.

In a particular embodiment, the driver according to the present invention is provided with a memory 96, containing a predefined relationship between duty cycle and power setting, for instance in the form of a formula or a table. The control circuit 92 of the driver is designed to receive an input signal S, to select a duty cycle D on the basis of this input signal S, and to select a corresponding power setting from the relationship stored in said memory 96. The control circuit 92 is further designed to control the down-converter 64 and the commutator 65 such that the lamp is operated at the duty cycle and power setting as determined by said relationship on the basis of said input signal. To this end, the control circuit 92 is provided with an output voltage sensor 97.

In operation, when a user varies the said input signal, the color temperature of the lamp varies accordingly, substantially without delay. The user may thus select a desirable color temperature, and maintain the input signal constant to maintain this desirable color temperature. It is also possible that the input signal is a continuously varying signal, for instance generated by a signal generating unit (not shown in the drawing) in order to obtain a light source with continuously varying, possible repetitively varying, color temperature.

In a simple embodiment, a driver according to the present invention is adapted to keep the current intensity at a fixed value when the duty cycle is varied. The control unit 92 of the driver is designed to receive an input signal, to select a duty cycle D on the basis of this input signal, but to set the current intensity to a fixed value which does not depend on the duty cycle. The control unit 92 is further designed to control the commutator 65 such that the lamp is operated at the duty cycle as selected on the basis of said input signal, and at a constant current intensity corresponding to said fixed value.

In a further elaboration of this simple embodiment, the control circuit 92 has a second control input 98 for changing said fixed value of the current intensity. This allows a user, if desired, to change the setting of the fixed current intensity value. In another elaboration of this simple embodiment, the down-converter 64 is not controllable by the control circuit 92. Effectively, this means that the down-converter 64 has a fixed setting.

In this simple embodiment, when the duty cycle is increased such as to travel the color line from low temperature to high temperature, the shifting particle distribution results in an increase of the lamp voltage. At fixed current magnitude, this corresponds to an increase of the electrical lamp power. It is noted that the rate of increase of lamp power depends on the value of the fixed current magnitude.

It should be clear to a person skilled in the art that the present invention is not limited to the exemplary embodiments discussed above, but that several variations and modifications are possible within the protective scope of the invention as defined in the appending claims.

For instance, although the present invention has been described in relation to duty cycle control, the control circuit 92 may also be designed to set a certain average DC value in response to the control signal S received at its control input 93.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Method for driving a gas discharge lamp (1), specifically a HID lamp, more specifically a metal halide lamp, most specifically a metal halide lamp with an aspect ratio larger than 3 or even 4, wherein the lamp is supplied with a commutating DC current having a duty cycle (D) and an average current intensity (I_{AV}) at a certain electrical output power; the method comprising the step of varying the average current intensity (I_{AV}) and the electrical output power in order to vary the color temperature of the lamp.

2. Method according to claim 1, wherein, when the average current intensity (I_{AV}) is changed such as to effectively result in an increase in the color temperature of the lamp, the electrical output power is increased.

3. Method according to claim 1, wherein the average current intensity (I_{AV}) and the electrical output power are varied within a current range and a power range, respectively, having upper and lower current limits and upper and lower power limits, respectively, such that the color temperature of the lamp is varied within a temperature range having an upper temperature limit and a lower temperature limit;
wherein the electrical output power is set at the upper power limit when the color temperature of the lamp is at the upper temperature limit, and wherein the electrical output power is set at the lower power limit when the color temperature of the lamp is at the lower temperature limit.

4. Method according to claim 3, wherein, at least within a part of said temperature range, the electrical output power is varied proportional to variations in the average current intensity (I_{AV}).

5. Method according to claim 1, wherein the average current intensity (I_{AV}) and the electrical output power are varied such as to keep the color rendering index (CRI) at a substantially constant value.

6. Method according to claim 1, wherein the average current intensity (I_{AV}) and the electrical output power are varied such as to keep the light output (lumen) at a substantially constant value.

7. Method according to claim 1, wherein the average current intensity (I_{AV}) is changed by changing the duty cycle (D).

8. Method according to claim 7, wherein, in each setting of the duty cycle (D), a positive current magnitude (I1) is equal to a negative current magnitude (I2).

9. Method according to claim 8, wherein, when the average current intensity (I_{AV}) is varied, the absolute value of the current magnitude is maintained at a fixed value, irrespective of the actual value of the average current intensity (I_{AV}).

10. Method according to claim 1, practiced on a high-pressure lamp (above 10 atm) arranged in a vertical orientation, wherein the color temperature is varied over a temperature range having a lower temperature limit in the order of 2800 K or lower and having an upper temperature limit in the order of 4000 K or higher.

11. Driving apparatus (60) for driving a gas discharge lamp (1), specifically a HID lamp, more specifically a metal halide lamp, most specifically a metal halide lamp with an aspect ratio larger than 3 or even 4, the apparatus comprising:
current generating means (61, 62, 63, 64) for generating a current with a substantially constant current intensity;
commutating means (65) for receiving said current, and having an output for connecting to a lamp (1), the commutating means (65) being arranged for commutating said current;
the driving apparatus being designed to execute a method according to any of the previous claims.

12. Driving apparatus according to claim 11, wherein the driver (60) is provided with a control circuit (92) having a control input (93) for receiving a control signal (S) and having a control output (94; 95) for controlling the driver (60), and wherein the control circuit (92) is responsive to a control signal (S) received at its control input (93) to control the driver (60) such as to set an average current intensity (I_{AV}) in accordance with the control signal (S).

13. Driving apparatus according to claim 12, further comprising a memory (96) containing a relationship between average current intensity (I_{AV}) and electrical output power;
wherein the control circuit (92) is designed to control a down-converter (64) in order to set the electrical output power on the basis of the relationship stored in said memory.

14. Driving apparatus according to claim 12, wherein the control circuit (92) is designed to control the commutating means (65) such as to set a certain value of the duty cycle (D) in order to set a certain value of the average current intensity (I_{AV}).

15. Driving apparatus according to claim 14, further comprising a memory (96) containing a relationship between duty cycle and electrical output power;
wherein the control circuit (92) is designed to control a down-converter (64) in order to set the electrical output power on the basis of the relationship stored in said memory.

16. Driving apparatus according to claim 12, wherein the control circuit (92) is designed to control a down-converter (64) in order to set the output current magnitude at a fixed value independent from the average current intensity (I_{AV}).

17. Driving apparatus according to claim 16, wherein the control circuit (92) comprises a current magnitude selection input (98), and is responsive to a command input received at this second input (98) to set said fixed value.

18. Driving apparatus according to claim 12, adapted for variable current-controlled particle distribution shift, wherein the driving apparatus (60) is provided with a control setting device (91) coupled to said control input (93) of said control circuit (92);
wherein the control setting device (91) is arranged for generating a control signal (S) which is continuously variable within a predetermined range;
and wherein the control circuit (92) is arranged to continuously vary the average current intensity (I_{AV}) and output power of the commutating lamp current in response to said control signal (S).

19. Variable color temperature light generating system (90), comprising:
a gas discharge lamp (1), specifically a HID lamp, more specifically a metal halide lamp, most specifically a metal halide lamp with an aspect ratio larger than 3 or even 4, preferably a high-pressure lamp having a lamp pressure over 10 atm;
a driving apparatus (60) according to any of claims 11-18, the driving apparatus being capable of driving the lamp with a variably settable average current intensity (I_{AV}) and correspondingly variably settable output power in order to induce a variable current-controlled particle distribution shift in the lamp, such as to allow a color point to travel a color line in the chromaticity diagram.
